(19) United States
(12) Patent Application Publication
(10) Pub. No.: US 2025/0201896 A1
(43) Pub. Date: Jun. 19, 2025

(54) APPARATUS AND METHOD FOR FORMING AND CONVEYING CELL STACKS FORMED BY SEGMENTS FOR THE ENERGY CELL PRODUCING INDUSTRY

(71) Applicant: KÖRBER TECHNOLOGIES GMBH, Hamburg (DE)

(72) Inventors: Jan KREYSERN, HAMBURG (DE); Marcus WAGNER, HAMBURG (DE); Michael KLEINE WÄCHTER, LANKAU (DE); Karsten MEINKE, MÖLLN (DE); Nils HOFMANN, OTTERSBERG (DE); Manfred FOLGER, HAMBURG (DE); Patrick GÖGEL, HAMBURG (DE)

(21) Appl. No.: 18/844,319

(22) PCT Filed: Mar. 7, 2023
(86) PCT No.: PCT/EP2023/055727

§ 371 Date: Sep. 5, 2024

(30) Foreign Application Priority Data
Mar. 8, 2022 (DE) 10 2022 105 394.6

(51) Int. Cl. H01M 10/04; B65G 61/00

(52) U.S. Cl. CPC H01M 10/0404; B65G 61/00

(57) ABSTRACT

The invention relates to an apparatus for forming and conveying cell stacks formed by segments for the energy cell producing industry, said apparatus comprising—at least two cell stacking devices which are designed to place the segments on top of each other to produce cell stacks, and—at least one feed device, each of which is designed to feed the segments to the cell stacking devices, wherein—a transport system having a plurality of individually movable transport units is provided, which are designed to convey the cell stacks produced by the cell stacking devices from a pick-up area into a delivery area that is spatially remote from the pick-up area, wherein—each of the cell stacking devices forms a cell stack in or on one of the transport units, and—the transport units in the pick-up area can be removed from the transport system in order to form the cell stack.

The present invention relates to an apparatus for forming and conveying cell stacks formed by segments for the energy cell producing industry having the features of the preamble of claims 1 and 9. The invention also relates to a corresponding method.

Energy cells or energy stores within the meaning of the invention are used, for example, in motor vehicles, other land vehicles, ships, aircraft or in stationary systems such as photovoltaic systems in the form of battery cells or fuel cells, in which very large amounts of energy have to be stored for long periods of time. For this purpose, such energy cells have a structure consisting of a plurality of segments stacked to form a stack. These segments are alternating anode sheets and cathode sheets, which are separated from each other by separator sheets which are also manufactured as segments. The segments are pre-cut in the production process and then placed on top of each other in the predetermined sequence to form the stacks and joined together by lamination. The anode sheets and cathode sheets are first cut from a continuous web and then placed individually at intervals on a continuous web of separator material. This subsequently formed “two-ply” continuous web made of the separator material with the anode sheets or cathode sheets placed on top is then cut into segments again in a second step using a cutting device, wherein the segments in this case are formed in a double layer by a separator sheet with an anode sheet or cathode sheet arranged on top. Where technically feasible or necessary from a manufacturing perspective, the continuous webs of separator material with the anode sheets and cathode sheets placed on top of them can also be placed on top of one another before cutting, so that a continuous web is formed with a first endless layer of separator material with anode sheets or cathode sheets placed thereon and a second endless layer of separator material with anode sheets or cathode sheets placed thereon. This “four-ply” continuous web is then cut into segments by means of a cutting device, which segments are in this case formed in four layers with a first separator sheet, an anode sheet, a second separator sheet and a cathode sheet lying thereon. Such a solution is known, for example, from WO 2020/192845A1. The four-ply web can also be formed by the arrangement of a first separator sheet, a cathode ball, a second separator sheet, followed by an anode sheet.

Segments within the meaning of this application are therefore single-ply segments of a separator material, anode material or cathode material, double-ply or four-ply segments of the structure described above.

Devices for producing battery cells are known, for example, from WO 2016/041713 A1 and DE 10 2017 216 213 A1.

An apparatus for producing an electrode stack is also known from WO 2019/048589 A1. For this purpose, a transport system having carriages is provided, on which electrode and separator layers can be stacked. There are stacking stations at which only separator layers are deposited, stacking stations at which only cathode layers are deposited and stacking stations at which only anode layers are deposited. By moving the carriage to the stacking stations, a cell stack can thus be stacked in the desired sequence on the carriage's setdown surface.

An apparatus for producing a battery cell is also known from US 2002/0007552 A1. After a battery cell has been produced, it is transferred to a conveyor belt using the “pick and place” principle.

Nowadays, the production of battery cells, for example for electromobility, is carried out on production lines with a capacity of 100 to 240 monocells per minute. These work in sub-areas or continuously with clocked discontinuous movements, such as back-and-forth movements and are therefore limited in terms of production capacity. Most known machines operate using the single-sheet stacking method (e.g. “pick and place”) with the disadvantage of slower processing. Laminating cell formations is not possible here.

Another well-known approach involves a machine having continuously running material webs and clocked tools, such as cutting blades and tools for adjusting divisions.

In principle, machines with clocked movements are limited in terms of performance. The parts with mass, such as receptacles and tools, must be constantly accelerated and decelerated. The processes determine the timing and a great deal of energy is consumed. The mass of the moving parts cannot be reduced arbitrarily. Faster moving parts often have to endure higher loads and therefore become more complex and heavier.

In order to reduce the production costs of battery manufacturing, the production capacity of the machines must be increased, among other things. A prerequisite for high production output is a high production rate of the stacks of energy cells, which are formed from a plurality of segments of the type described above and which are stacked on top of each other.

In a preceding manufacturing step, the segments are placed on top of one another in a first step to produce what are known as monocells, consisting of a first separator sheet, an anode sheet arranged thereon, a second separator sheet arranged thereon and a cathode sheet arranged thereon; the monocell can also have the following layer sequence: first separator sheet, cathode sheet arranged thereon, second separator sheet arranged thereon and anode sheet arranged thereon.

Alternatively, the separator sheets can be initially guided as two continuous webs, wherein the already cut segments in the form of the anode sheets are placed on one of the continuous webs and the already cut segments in the form of the cathode sheets are placed on the other continuous web and joined together by a lamination process. The composite webs thus prefabricated are then bonded together in a further lamination process to form a four-ply composite web.

In principle, it is also possible to place the first cut electrode in the form of the cathode or anode between the separator sheets in the form of the continuous webs and to place the second cut electrode in the form of the anode or cathode on or under one of the separator sheets. The four-ply web is then laminated in a combined lamination process, so that the monocell is produced in a fixed formation while the continuous webs still remain, i.e. before cutting.

Regardless of whether the monocells are manufactured using a one- or two-stage lamination process, the monocells are then cut from the composite web by cutting through the spaces between the successive anode sheets or cathode sheets.

Alternatively, the continuous webs of separator material with the anode sheets and cathode sheets arranged thereon can also be cut first, wherein the monocells are then produced by means of a downstream bonding process of a first cut separator sheet with an anode to a second cut separator sheet with a cathode.

The segments are then stacked on top of each other to produce a stack of a plurality of segments. If the segments are monocells or separator sheets with anode or cathode sheets arranged thereon, a cathode or anode will be located on a free side surface of the stack, which is then covered by the arrangement of what is known as a closing cell. The closing cell comprises a first separator sheet, an anode or cathode sheet arranged thereon and a second separator sheet arranged thereon, on which, however, no cathode or anode sheet is arranged. This means that the closing cell can also be regarded as a monocell without a cathode or anode sheet. The finished stack formed from the plurality of monocells and the closing cell is then characterised in that it has one separator sheet in each case on its top side and on its underside, and the anode sheets and cathode sheets are each covered on the top side and on the underside by separator sheets and are not in contact with each other. Alternatively, the closing cell can also be formed by an electrode, for example in the form of an anode. If the monocell is formed by the layer sequence of the first separator sheet, the cathode sheet arranged thereon, the second separator sheet arranged thereon and the anode sheet arranged thereon, then the arrangement of the closing cell in the form of the anode allows the two side surfaces of the cell stack formed to be closed with an anode. The cell stack, which ends with two electrodes, here in the form of two anodes, is then wrapped in an insulator.

During the formation of cell stacks, however, delays can arise for different reasons. However, no solutions are known from the prior art as to how these delays can be avoided without negatively affecting production output.

Against this background, the object of the invention is to provide an improved apparatus for forming and conveying cell stacks for the energy cell producing industry, which makes possible a more reliable provision of cell stacks, as well as a corresponding method.

The object is achieved by the features of the independent claims. Further is preferred embodiments of the invention can be found in the dependent claims, the figures, and the associated description.

According to a first aspect of this application, the object is achieved by an apparatus for forming and conveying cell stacks formed by segments for the energy cell producing industry, comprising at least two cell stacking devices, which are designed to place the segments on top of each other to produce cell stacks, and at least one feed device, each of which is designed to feed the segments to the cell stacking devices, wherein a transport system having a plurality of individually movable transport units is provided, which are designed to convey the cell stacks produced by the cell stacking devices from a pick-up area into a delivery area spatially remote from the pick-up area, wherein in each case one of the cell stacking devices forms a cell stack in or on one of the transport units, and the transport units in the pick-up area can be removed from the transport system to form the cell stack.

The term individually movable transport units means that the movement of individual transport units, for example the movement speed or the movement route, can be adjusted separately, at least in some regions of the transport system. The individual mobility of the transport units can be achieved, for example, by means of transport vehicles which are designed to convey the transport units. The transport vehicles can, for example, be moved on a rail system. Furthermore, it is also possible, for example, for the transport units to be formed by transport vehicles.

The individual mobility of the transport units offers significant optimization potential for the removal of the transport units from the transport system and their subsequent return. For example, removals and/or returns can take place in parallel or transfer times can be calculated in advance and taken into account early on when planning transport orders.

The removal of the transport units from the transport system for the formation of the cell stacks from segments means that the formation of the cell stacks can be decoupled from the transport process of the cell stacks between the pick-up area and the delivery area. In this way, the segments can be reliably placed on top of each other to produce cell stacks by the particular cell stacking device, independently in terms of timing of any framework conditions of the transport system. Decoupling the timing of cell stack formation from the clocking of the transport system offers the advantage that the cell stacks can be completed with almost no time constraints. This is particularly important considering potential defective segments, as these can delay the completion of the cell stacks.

The proposed solution allows the process of cell stack formation to be parallelised by the at least two cell stacking devices. Preferably, exactly four cell stacking devices are provided so that any delay in cell stack formation at one of the cell stacking devices can be compensated for by the remaining three cell stacking devices. However, the degree of parallelisation in cell stack formation can be further scaled, so that more than four cell stack devices can be provided.

After the segments have been stacked to form a cell stack of a predefined cell stack height, i.e. after the cell stack has been completed, the transport unit is returned to the transport system together with the completed cell stack so that the cell stack can be conveyed by the transport system together with the transport unit from the pick-up area to the delivery area. The process of cell stack formation and the transfer to the transport system can take place in parallel at each of the cell stacking devices.

Preferably, the segments stacked by the cell stacking devices are monocells.

Preferably, at least one changing device is provided by means of which a transport unit filled with a cell stack by one of the cell stacking devices can be replaced by an empty transport unit. The transport units replaced by the changing device are in a state of having been removed from the transport system. The changing device thus takes over the function of feeding the transport unit to one of the cell stacking devices and removing the transport unit from the particular cell stacking device together with the finished cell stack. The changing device thus allows the transport units to be conveyed when they have been decoupled from the transport system by being removed therefrom. Preferably, the changing device has a frame-like structure so that the at least one transport unit can be stored inside the frame; this is then referred to as a changing frame. Furthermore, the changing device is designed and movable in such a way that it can be moved between at least two, preferably exactly two, positions. Preferably, each of the cell stacking devices is assigned its own changing device.

It is further proposed that the at least one changing device has a first and a second storage position for storing one of the transport units, wherein the at least one changing device is designed to transfer the transport unit from the first storage position to the second storage position. For example, this is done by having the transport units movably mounted in the preferably frame-like changing device. In this way, the changing device in a first position can receive the transport unit in the first storage position, while in the second storage position a further transport unit is arranged opposite the cell stacking device in such a way that the segments are already placed on top of each other to produce a cell stack. Subsequently, by moving the changing device in a first direction, the first storage position with the empty transport unit can be arranged opposite the cell stacking device in such a way that the cell stack can be formed there; the changing device is then in the second position. At the same time, this movement of the changing device in the first direction shifts the second storage position in such a way that the transport unit together with the cell stack is positioned for transfer to the transport system. After the second storage position has been released again by the transport unit being delivered to the transport system, the changing device can be moved in a second direction, which is opposite the first direction, while the transport unit remains in the position in which it is loaded with segments by the cell stacking device; for this purpose, for example, a holding element which holds the transport unit in position can be provided. The changing device is now back in the first position. By moving the changing device relative to the transport unit, the transport unit changes from the first storage position to the second storage position, so that the first storage position becomes free again and can receive an unloaded transport unit. As soon as the first storage position is occupied by a transport unit again, the changing device is moved in the first direction again so that the empty transport unit can be supplied with segments by the cell stacking device. This process can then repeat continuously. By changing the transport unit from the first storage position to the second storage position, the process of cell stack formation can be decoupled from the transfer of the transport units. In this way, an empty transport unit can already be received in the first storage position at the same time as the cell stack is being formed in the second storage position. By the transfer of the transport units to and from the transport system being decoupled from the formation of the cell stack on the transport unit, these process steps can take place in parallel, resulting in a larger time window for the transfer of the transport units from the transport system to the changing device and vice versa. In addition, in this way the changing device can serve three positions, even though it is only moved in two positions. The three positions are as follows: In a first position (receiving position), the changing device receives the transport unit from the transport system. In a second position (stacking position), the cell stack is formed by the cell stacking device on the transport unit. In a third position (delivery position), the changing device returns the transport unit to the transport system.

Preferably, the at least one changing device is movable on a level which is arranged above or below a transport system level on which the transport units are removed from the transport system and/or transferred back to the transport system. This ensures that the transport system is arranged below or above the changing device, at least in the pick-up area. By arranging the levels in this way, a physical decoupling of the conveying movement of the transport system from the conveying movement of the changing device can be achieved in a simple manner. Alternatively, it is of course also is possible to achieve physical decoupling by arranging the changing device laterally next to the transport system. Preferably, the changing device for conveying the transport unit performs a linear movement.

It is further proposed that each of the cell stacking devices is assigned a first and/or a second lift by means of which the transport units can be conveyed between the level of the changing device and the transport system level. The first and/or second lift can transfer the transport unit from the transport system to the changing device and vice versa. The lifts therefore provide a simple mechanical solution for the transfer process. Preferably, the first lift is designed to lift one of the transport units from the transport system into the changing device. Further preferably, the second lift is designed to lower the transport unit from the changing device to the transport system below. Preferably, the transport units are conveyed by the transport system between the pick-up area and the delivery area in a horizontal plane, whereas the lifts convey the transport units in a vertical direction.

If the embodiment of the changing device having the two storage positions as described above is used, the first lift can, for example, transfer the transport unit to the first storage position of the changing device when the latter is in a first position. In addition, the transport unit can be transferred to the second lift when the transport unit to be transferred is in the second storage position and the changing device is in the second position.

In addition, it is advantageous if each cell stacking device is assigned its own changing device and, accordingly, each changing device is assigned a first and a second lift. In this way, the transport units can be removed and returned between the transport system and the particular cell stacking device independently of the other cell stacking devices. The system reliability of the apparatus can thus be further increased.

Preferably, the transport system comprises a plurality of transport vehicles which are designed to move the transport units individually in the transport system, wherein the particular transport vehicle can be moved to a second transfer position in is an unloaded state after the transfer of one of the transport units to the at least one changing device in a first transfer position in order to receive a ready transport unit with a finished cell stack. Preferably, the transport vehicle with the unloaded transport unit is not driven to the first transfer position until a transport unit loaded with a finished cell stack is already ready at the second transfer position. In the first transfer position, the unloaded transport unit can thus be transferred to the changing device via the first lift. In the second transfer position, the transport unit loaded with the cell stack is transferred back to the ready transport vehicle by the second lift. The transport vehicles do not have to be permanently assigned to the transport units. In addition, this preferred embodiment makes it possible for the transport vehicles to transport the cell stacks away serially without the transport vehicles interfering with each other.

Preferably, the segments are placed on top of each other to produce a cell stack on a height-adjustable base in or on one of the transport units. For example, the height-adjustable base can be part of the transport unit itself. Alternatively, the height-adjustable base can also be formed completely or partially by elements which are not assigned to the transport unit but are part of the rest of the apparatus. The height-adjustable base allows the delivery height of each segment to the stack to be kept constant. This offers the advantage that the cell stacking device can deposit the cells with greater accuracy and reliability.

It is further proposed that the transport units each have a setdown surface having recesses for the cell stack, wherein the apparatus comprises fins which are arranged such that they project into the recesses of the setdown surface when one of the transport units is in a position in which the transport unit is filled with segments by one of the cell stacking devices, wherein an adjusting device is provided by means of which the degree of engagement of the fins in the recesses can be adjusted such that the fins form the height-adjustable base for the transport unit. The height-adjustable base is thus formed by a component that is not part of the transport unit, namely the fins which project into the recesses of the transport unit in the stacking position. The adjusting device preferably comprises an actuator for moving the fins, which is arranged so as to be stationary on the apparatus. This means that corresponding drives and mechanical components do not have to be arranged on the transport units. The transport units can therefore be made lighter and produced more cost-effectively. In order not to block the movement of the changing device, the fins can be moved completely out of the recesses in the setdown surface of the transport unit after the cell stack has been formed.

For example, the fins can also serve as a holding element for holding the transport unit when it is in engagement with the recess. When the changing device moves in the second direction, the transport unit held in place by the fins can be moved from the first storage position to the second storage position.

According to a second aspect of this application, an apparatus for forming and conveying cell stacks formed by segments for the energy cell producing industry is proposed in order to achieve the object, comprising at least two cell stacking devices, each of which is designed to place the segments on top of each other in order to produce cell stacks, and a feed device which is designed to feed the segments to the cell stacking devices, wherein a transport system having a plurality of individually movable transport units is provided, which are designed to receive the cell stacks produced by the cell stacking devices in a pick-up area and to deliver them again in a delivery area, wherein each of the cell stacking devices places the segments on top of each other in a magazine of a rotatable magazine drum to produce the cell stack, wherein the magazine has a lifting device by means of which the depth of the magazine can be adjusted depending on the increasing stack height of the segments in the magazine.

With this solution, the formation of cell stacks can also be carried out in parallel by the plurality of cell stacking devices. In addition, by forming the cell stacks in the magazines of the magazine drums, a decoupling of the cell stack formation from the clocking of the transport system is achieved. The lifting device ensures that the top segment can be placed on the cell stack at a constant height, so that the cell stack can be formed reliably and with high quality. Preferably, each of the magazine drums comprises two or four magazines. Each cell stacking device is preferably assigned its own magazine drum.

Preferably, the magazine drum comprises pivotable gripper elements with which the cell stack can be fastened or released in the magazine depending on the pivoting position of the gripper elements, wherein the pivotable gripper elements are coupled to the lifting device in such a way that the lifting device performs a lifting movement together with the gripper elements. The magazine is preferably filled with the segments by the cell stacking device through an upward-facing magazine opening. For delivery to the transport unit, the magazine drum preferably rotates by 180° so that the particular magazine opening points downwards and the cell stack would drop out if not secured. The gripper elements, which are coupled to the lifting device, allow the cell stack to be held reliably in the magazine by applying a clamping force.

It is further proposed that, a common lifting movement of the lifting device and the gripper elements allows the cell stack to be transferred to one of the transport units in a state clamped between the lifting device and the gripper elements. This means that the lifting device can be used not only to keep the height of the top layer of the cell stack constant for the stacking process but also to transfer the cell stack to the transport unit. By coupling the lifting device to the gripper elements, the cell stack can be transferred from the magazine drum to the transport unit by applying a clamping force. The correct arrangement and alignment of the individual segments of the cell stack can thus be maintained even during transfer to the transport unit because the segments forming the cell stack are reliably held together by the clamping force.

The preferred embodiments proposed below are compatible not only with the solution according to the first aspect of this application but also with the solution according to the second aspect of this application. A corresponding combination is explicitly included in the disclosure content of this application.

The transport units are preferably containers which are open on one side. Preferably, the container forms a receptacle corresponding to the shape of the cell stack. This design of the transport unit allows the cell stack to be placed and stored in the container in a precise position; in particular, displacement of the individual segments relative to one another can be prevented to a certain extent.

According to a further preferred embodiment, it is proposed that the transport units each comprise one or more gripper arms with which the cell stack can be fastened to the transport unit. This ensures that the arrangement and alignment of the individual segments of the cell stack with respect to each other can be maintained even when the transport devices are being transported through the transport system. Preferably, the gripper arms can be actuated by an actuating device of the apparatus, which, however, is not part of the particular transport unit.

According to a further preferred embodiment, it is proposed that an unloading apparatus is provided in the delivery area, by means of which the cell stacks are removed from the transport units, and the unloaded transport units can be made available again by the transport system at the cell stack devices. Preferably, a waiting area can be provided in which the transport units are parked until an unloaded transport unit is required at one of the cell stacking devices and is retrieved from the waiting area. Such control or regulation of the transport units can be carried out by means of a centralised or decentralised control unit.

According to a further preferred embodiment, it is proposed that the feed device comprises at least one transfer drum, wherein each of the cell stacking devices comprises at least one segment drum, by means of which the segments are picked up from the transfer drum at a transfer speed and are delivered at a delivery speed, wherein the transfer speed is greater than the delivery speed. Preferably, the transfer speed corresponds to the circumferential speed of the transfer drum. Preferably, the delivery speed is zero, so that the segments are transferred to the transport unit or to the magazine drum at a standstill. This delay is made possible by distributing the segments over a plurality of segment drums. The stacking process is thus parallelised, and the delay allows the cell stack to be formed with higher quality. With this solution, the segments do not have to be assigned to a specific segment drum from the outset.

In addition, it may be necessary to increase the speed again after reception of the segment at the transfer speed, and only then to decelerate to zero. In the same way, after the segments have been delivered to the transport unit, they can first be accelerated to a speed which is greater than the transfer speed and then decelerated to the transfer speed. The corresponding speed of the segment drum is adjusted by adjusting the angular velocity of the segment drum. The temporary increase in speed from the transfer speed and the subsequent reduction in the speed of the segment drum is necessary, in particular in the case of segment drums having only a single receiving stamp designed to receive a segment, in order to reach the delivery position within one cycle. If, on the other hand, a segment drum having two independent receiving stamps or three receiving stamps in each case for one segment is used, this temporary acceleration and deceleration based on the transfer speed is not necessary or only necessary to a lesser extent. In practice, a segment drum having three receiving stamps aligned at angles of 120 degrees to each other has proven to be particularly advantageous.

If each of the segment drums comprises a plurality of receiving stamps, in particular three receiving stamps, the movement of the segment drums is preferably controlled in such a way that one of the segment drums is decelerated and accelerated overall without changing the distances between the receiving stamps. Each of the segment drums is formed here by a drum driven to rotate, so that the receiving stamps are in this case arranged at invariable angles to one another during the rotational movement. The receiving stamps are arranged equidistantly from each other and are driven together with the base body of their segment drum. The advantage of this solution is that the acceleration and deceleration of the segments at the transfer points described above is achieved solely by a single control of the movement of the segment drum, while the receiving stamps themselves do not perform an individualised controlled movement, but are decelerated and accelerated as an assembly. This allows the overall control and structural design to be simplified. In particular, the receiving stamps do not require any separate movable mounting on their particular segment drum. It is also possible to dispense with individual controllability of the receiving stamps, for example by means of a control profile.

Preferably, the segment drums can also be designed as double segment drums, i.e. two removal stamps rotate on a rotation axis, which are designed to receive a segment from the transfer drum and to release it again with a delay. The two sections of the double segment drum can, for example, have separate drives, i.e. be operated decoupled from each other, or work with the same drive profile but with a cyclical offset. The use of double segment drums allows the removal of the segments to be spread even further, giving the individual segments more time to decelerate and accelerate.

According to a further preferred embodiment, it is proposed that at least one comb-like depositing element having a plurality of prongs arranged parallel to one another is provided, wherein the prongs extend from a common base part, wherein the prongs engage in corresponding recesses of one of the segment drums during a rotational movement of the segment drum, wherein the comb-like depositing element can be moved in translation or rotated about the longitudinal axis of the base part in order to release the segments from the particular segment drum. The lever-like movement of the prongs, which results from the rotation of the base part around its longitudinal axis, allows the segments to be removed from the segment drum in an efficient manner. The rotational movement of the base part can, for example, be effected by a separate actuator. If the comb-like depositing element is mounted so as to be translationally movable, it has proven to be advantageous if it can be moved in a purely vertical lifting movement.

Preferably, the depositing lever has at least one contact opening which can be subjected to a negative pressure in order to receive the segment. When the segment is received from the segment drum by means of the depositing lever, at least one of its contact openings is subjected to a negative pressure, so that the segment is additionally attached to the storage lever by the effect of the negative pressure. If the segment drum is also subjected to a vacuum in order to hold the segments, the negative pressure holding the segment which is about to be transferred will be deactivated. When the segment combed out by the depositing lever is to be transferred from the depositing lever to a downstream device, the negative pressure applied to at least one contact opening of the deposit lever will also be deactivated again.

According to a further preferred embodiment, it is proposed that a control device is provided which is configured to individually control and/or regulate the movement speed and/or the movement route of the transport units loaded with the cell stacks between the pick-up area and the delivery area in such a way that a delayed completion of the cell stack at one of the cell stack devices can be compensated for in a compensation area between the pick-up area and the delivery area.

The individual control or regulation of the movement, i.e. the movement speed and/or the movement route, of the transport vehicles means that the arrival time of each individual transport unit in the delivery area can be influenced.

By reducing the movement speed, the arrival time in the delivery area can be delayed; by increasing the movement speed, an earlier arrival time can be achieved. If it is possible to change the movement route, the arrival time can be delayed by extending the movement route; shortening the route can result in an earlier arrival time. This means that the time sequence of the transport units arriving in the delivery area can be adjusted so that it is ideally coordinated with the downstream process. In addition, unforeseeable disruptions to the production process can be compensated for, thus increasing overall system reliability in cell stack production. In particular, any delays in the completion of the cell stacks can be compensated for in such a way that the transport units can be provided in the delivery area in a predetermined production cycle. Production processes downstream of the cell stacking process will not therefore be negatively affected by any delays in the cell stack formation process. The use of such a flexibly controllable or regulatable transport system also offers the advantage that downstream process steps can be approached in an adjusted manner. In addition, depositing positions of the segments or cell stacks can be corrected by means of the positioning of the transport units. Finally, time-critical processes can be parallelised and/or the transport clocking can be temporarily slowed down.

The control unit provided for controlling or regulating the movement can, for example, be a central control unit. However, it can also be, for example, a decentralised control unit whose components are assigned, for example, to the individual transport units or transport vehicles. For example, the control unit can also be a combination of centrally and decentrally arranged components.

As an alternative to the use of a linear rail system with transport units and/or transport vehicles, the transport system can be defined, for example, by a movement surface, preferably by a planar movement surface, on which corresponding transport vehicles can be moved. The transport vehicles can basically be moved in any direction on said movement surface, which results in additional degrees of freedom compared to a linear transport system. Transport systems having points or similar elements can also be used to determine or set different movement routes.

Preferably, the transport system can also be constructed in two parts. In a first part, the transport units can be moved flexibly and individually. This section is preferably is assigned to the part of the transport system from the pick-up area to the delivery area. In a second part of the transport system, however, the transport units can no longer be moved individually, but are conveyed at a uniform movement speed and/or on a uniform movement route. Said second part is preferably assigned to the delivery area. To implement the two-part transport system, it can, for example, have subdivided guides and/or drive elements; completely independent transport systems for the first and second subsystems are also conceivable, so that there must be a transfer device for the cell stacks, transport units and/or transport vehicles. In addition, it is conceivable to design the two-part transport system in such a way that a common guide is provided for the transport vehicles or transport units and the drive elements are designed differently depending on whether they belong to the first part or to the second part. In this case, the transfer is effected by means of overlapping drive elements with corresponding transfer of the transport unit or of the transport vehicles.

According to a further preferred embodiment, it is proposed that a processing unit for processing the cell stacks is provided between the pick-up area and the delivery area or within the delivery area, whereby the cell stacks are fed to the processing device by the transport system with the transport device. For example, the processing unit is designed to add additional material layers, such as an anode. The processing unit can, for example, be arranged in the compensation area. Preferably, the control device is then also designed to compensate for any delays which may arise during the processing of the cell stacks. Alternatively, the processing unit can also be arranged in the delivery area. This is advantageous because compensation has already taken place there, allowing also the processing unit to operate in the production cycle set by the control device.

According to a further preferred embodiment, it is proposed that the feed device comprises a reject device with which defective segments can be removed from the apparatus. Preferably, the reject device comprises a test drum which is designed to detect defective segments and an ejection drum by means of which the defective segments can be discharged into a rejects reservoir. The at least one reject device can ensure that only flawless segments are used to form the cell stacks. Because the segments are distributed over a plurality of, for example four, cell stacking devices, the rejection of individual segments by the reject device at the cell stack where the segment is missing leads to a delay in the completion of the cell stack. The predefined cell stack height is therefore only reached later at the cell stacking device in question, which results in irregular delivery of the cell stack to the transport units or delayed completion of the cell stack on or in the transport units in the pick-up area. However, the individual controllability of the transport units or transport vehicles in the transport system by the control unit makes it possible to compensate for this irregularity so that the cell stacks can be provided in the delivery area in a predetermined production cycle. In summary, product quality can be increased without negatively affecting the production cycle.

To achieve the object, according to a third aspect of this application, a method for forming and conveying cell stacks formed by segments for the energy cell producing industry is proposed, comprising the following steps:
a) moving a plurality of transport units between a pick-up area and a delivery area by means of a transport system;
b) removing one or more of the transport units from the transport system in a pick-up area of the transport system;
c) stacking segments in parallel to produce cell stacks of a predefined cell stack height on the removed transport units by means of at least two cell stacking devices;
d) returning the removed transport unit(s) together with the cell stack arranged on the transport unit to the transport system as soon as the cell stack on the particular transport unit has reached the predefined cell stack height.

With regard to the technical effects and advantages associated with this is method, reference is made to the above statements in connection with the apparatus according to the first aspect of this application.

Preferably, method step d) is followed by the following method step:
e) compensating for any time delays in the formation of the cell stacks by controlling and/or regulating the movement speed and/or the movement route of the transport unit in a compensation area arranged between the pick-up area and a delivery area, so that the cell stacks reach the delivery area in a predefined time interval.

This method can be carried out, for example, using the apparatus according to the first aspect of this application. The disclosure content of this application therefore also explicitly includes the implementation of this method using the apparatus explained above according to the first aspect of this application.

To achieve the object, according to a fourth aspect of this application a method for forming and conveying cell stacks formed by segments for the energy cell producing industry is proposed, comprising the following steps:
a) stacking segments in parallel to produce cell stacks of a predefined cell stack height by means of at least two cell stacking devices, wherein the cell stacks are formed in magazines of a plurality of magazine drums; preferably, each magazine drum is assigned to a cell stacking device;
b) adjusting the depth of the magazines during the cell stacking process to the height of the cell stack located in the particular magazine, so that the segments to be placed are placed at a constant height onto the cell stack;
c) clamping the cell stack in the magazine after the predefined cell stack height is reached;
d) transferring the cell stack in the clamped state to one of a plurality of individually movable transport units of a transport system in a pick-up area;
e) compensating for any time delays in the formation of the cell stacks by controlling and/or regulating the movement speed and/or the movement route of the transport unit in a compensation area arranged between the pick-up area and a delivery area, so that the cell stacks reach the delivery area in a predefined time interval.

With regard to the technical effects and advantages associated with this method, reference is made to the above statements in connection with the apparatus according to the second aspect of this application.

This method can be carried out, for example, using the apparatus according to the second aspect of this application. The disclosure content of this application therefore also explicitly includes the implementation of this method using the apparatus explained above according to the second aspect of this application.

The invention is explained below using preferred embodiments with reference to accompanying figures. In the drawings:

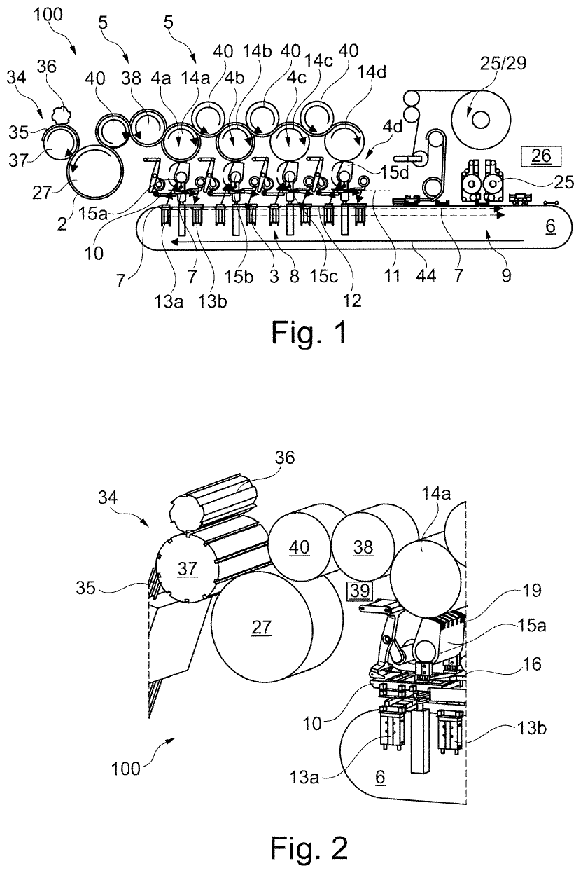

FIG. 1 shows an apparatus according to a first embodiment;

FIG. 2 is a detailed view of an apparatus according to a first embodiment;

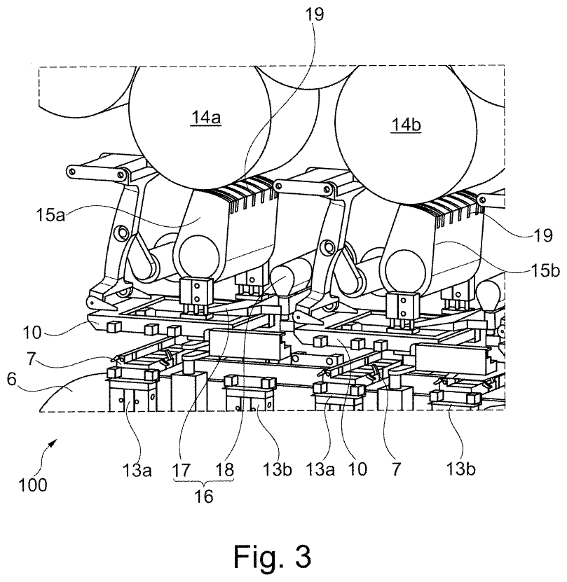

FIG. 3 shows an apparatus according to a first embodiment in a first method step;

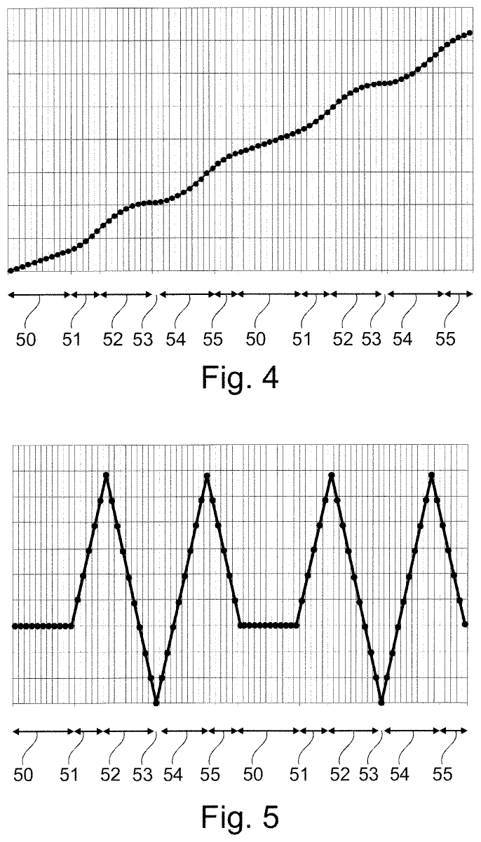

FIG. 4 is an angle/time diagram of a segment drum;

FIG. 5 is an angular velocity/time diagram of a segment drum;

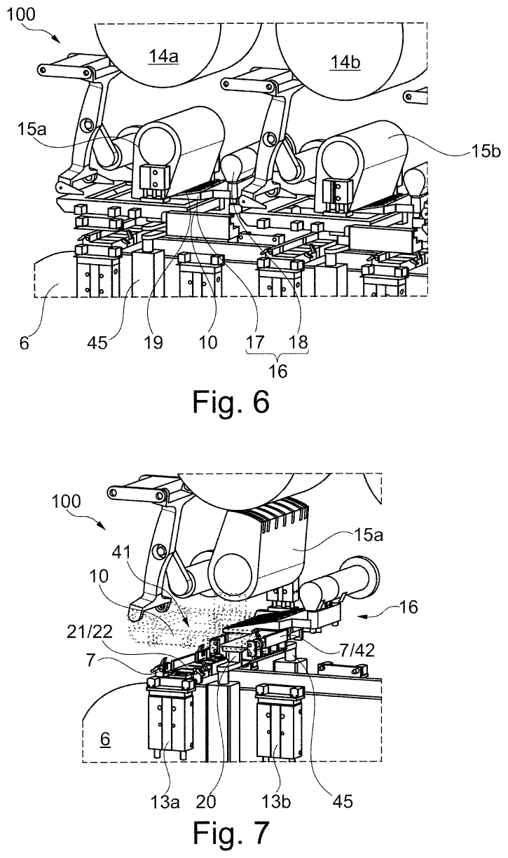

FIG. 6 shows an apparatus according to a first embodiment in a second method step;

FIG. 7 shows an apparatus according to a first embodiment in a third method step;

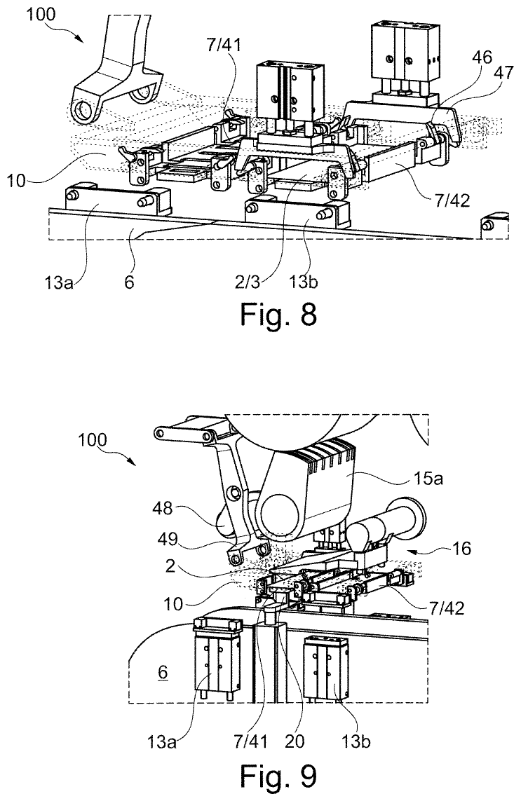

FIG. 8 shows an apparatus according to a first embodiment in a fourth method step;

FIG. 9 shows an apparatus according to a first embodiment in a fifth method step;

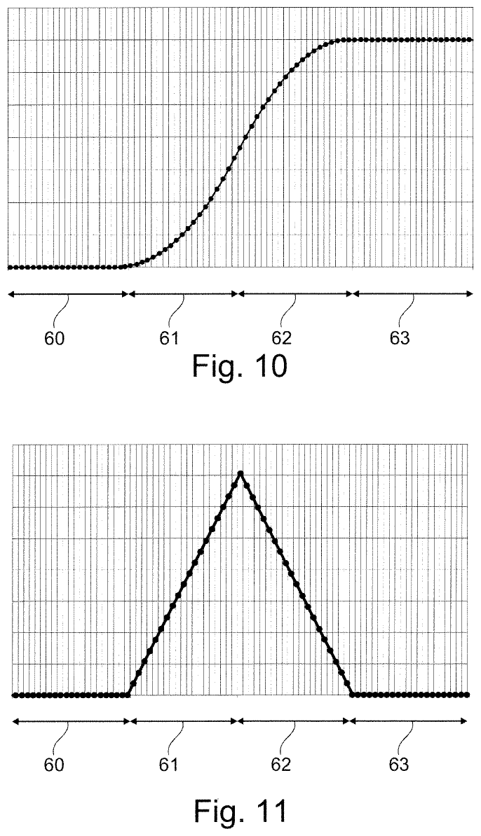

FIG. 10 is a distance/time diagram of a changing device;

FIG. 11 is a speed/time diagram of a changing device;

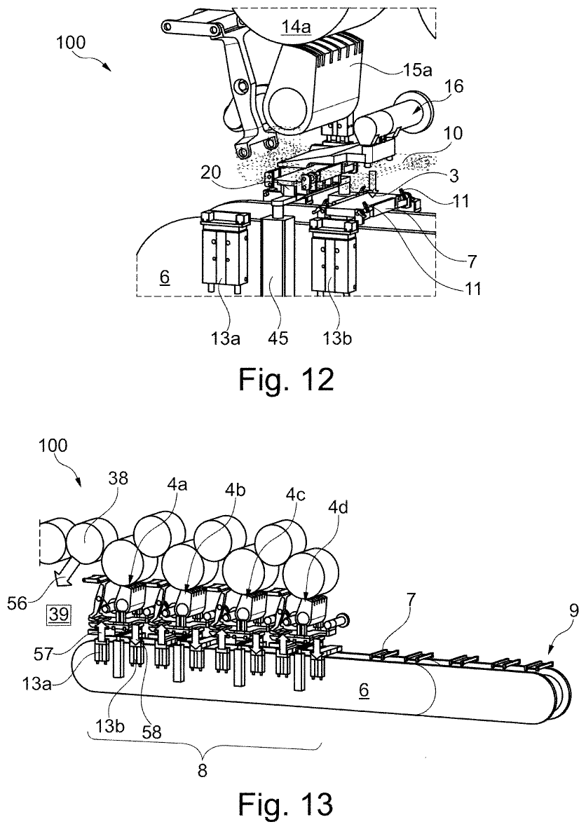

FIG. 12 shows an apparatus according to a first embodiment in a sixth method step;

FIG. 13 is a perspective view of an apparatus according to a first embodiment;

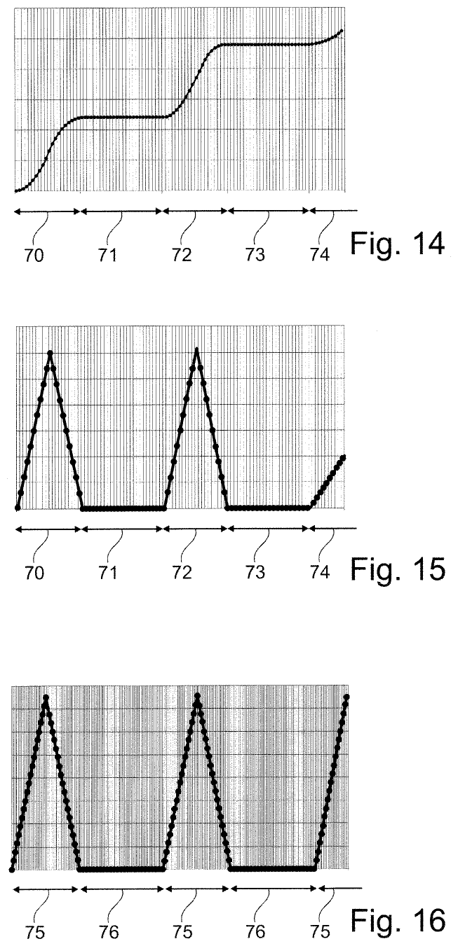

FIG. 14 is a distance/time diagram of a transport vehicle in a pick-up area;

FIG. 15 is a speed/time diagram of a transport vehicle in a pick-up area;

FIG. 16 is a speed/time diagram of a transport vehicle in a delivery area;

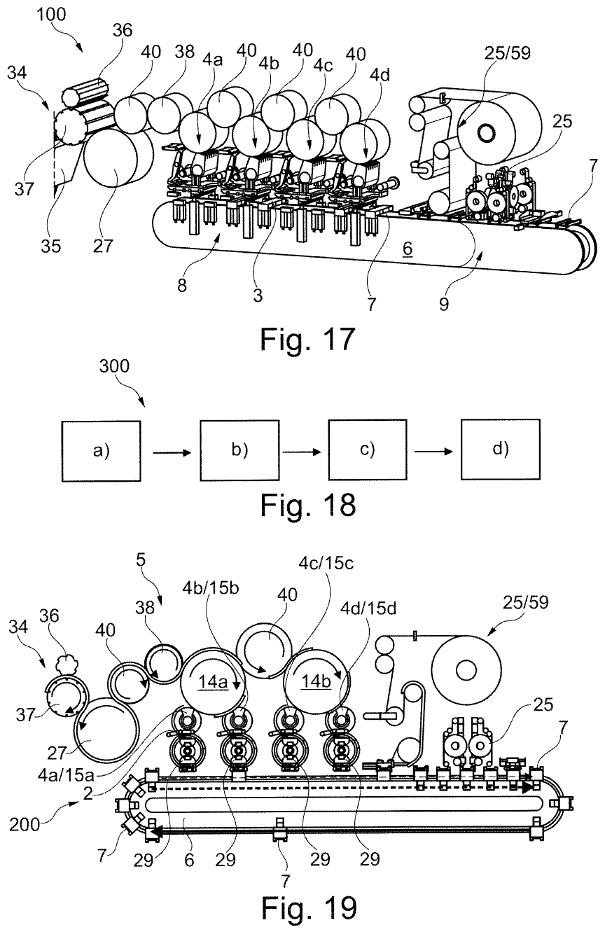

FIG. 17 shows an apparatus according to a first embodiment with a processing device;

FIG. 18 shows a first method for forming and conveying cell stacks;

FIG. 19 shows an apparatus according to a second embodiment;

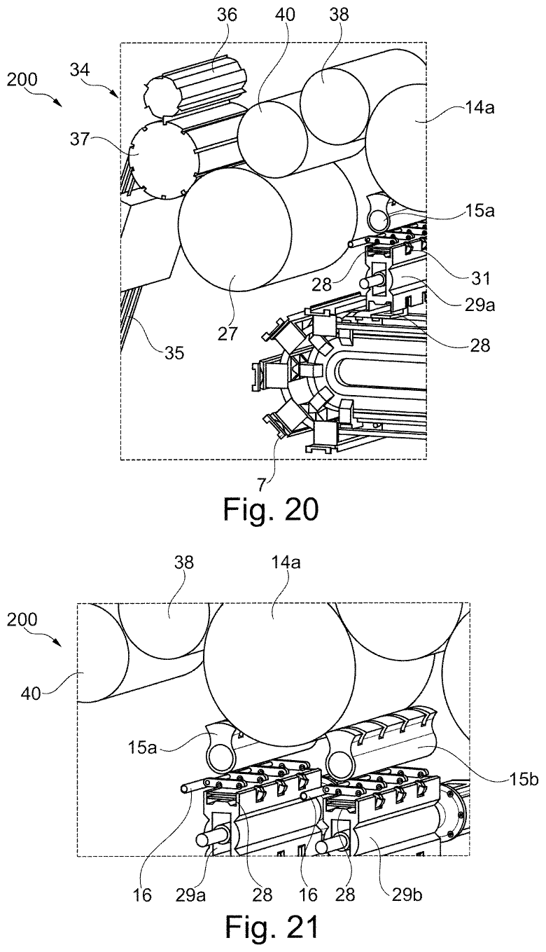

FIG. 20 is a detailed view of an apparatus according to a second embodiment;

FIG. 21 shows an apparatus according to a second embodiment in a first method step;

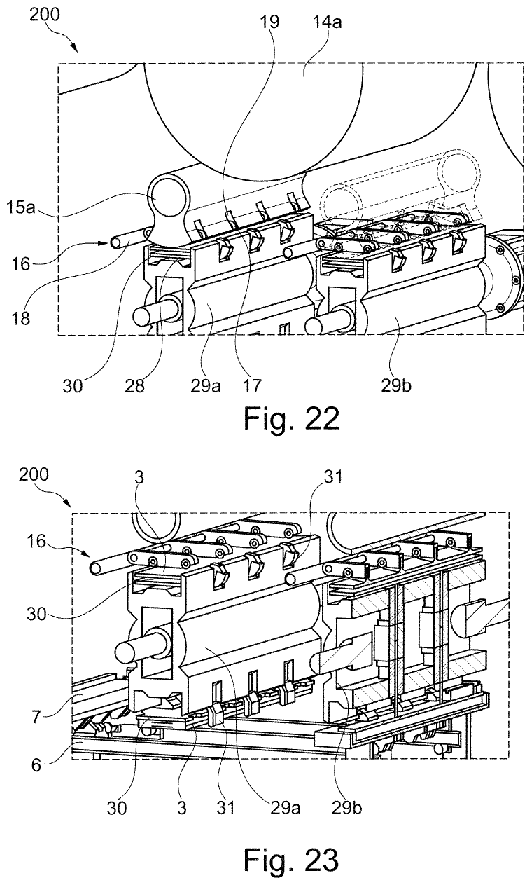

FIG. 22 shows an apparatus according to a second embodiment in a second method step;

FIG. 23 shows an apparatus according to a second embodiment in a third method step;

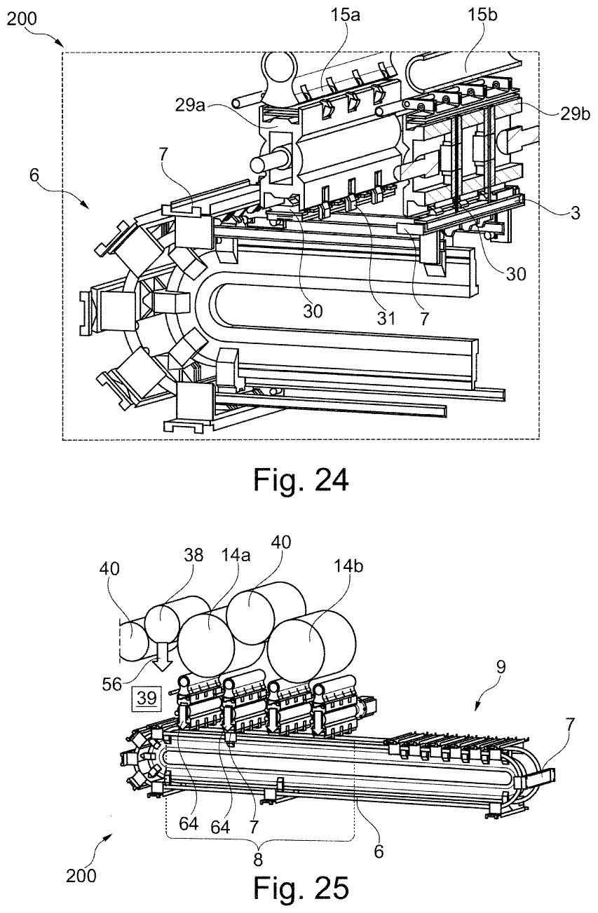

FIG. 24 shows an apparatus according to a second embodiment in a fourth method step;

FIG. 25 shows an apparatus according to a second embodiment in a perspective view;

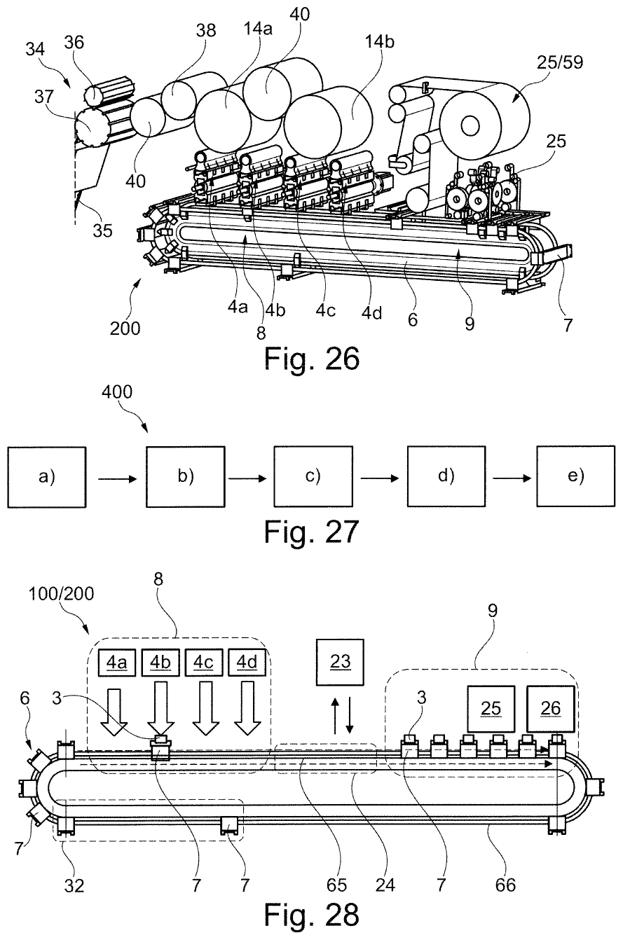

FIG. 26 shows an apparatus according to a second embodiment with a processing device;

FIG. 27 shows a second method for forming and conveying cell stacks;

FIG. 28 shows an apparatus according to a first or second embodiment comprising a transport system with a compensation area;

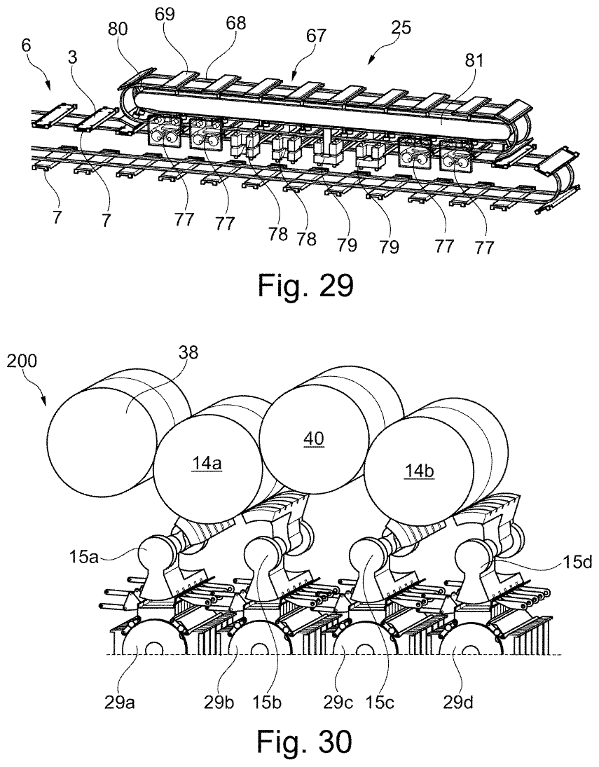

FIG. 29 is a detailed view of a processing device;

FIG. 30 shows an apparatus according to a second embodiment with segment drums in the form of double segment drums;

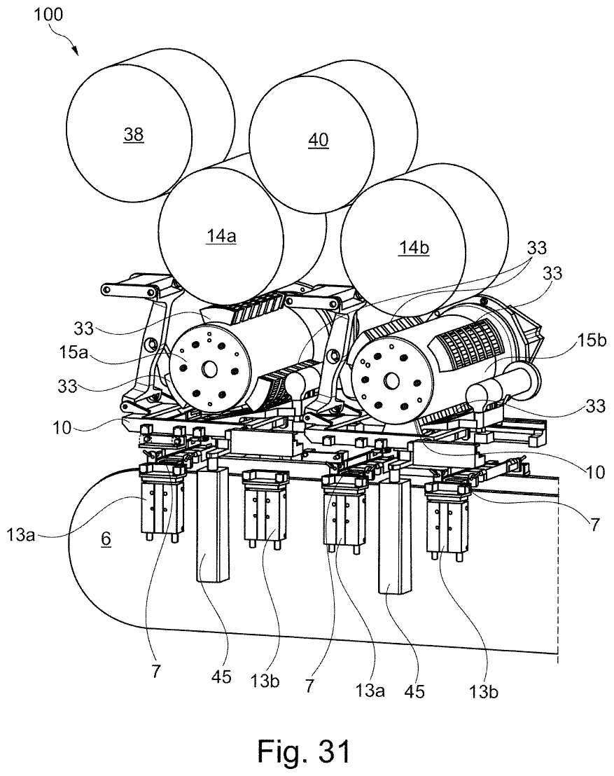

FIG. 31 shows an apparatus according to a variant of a first embodiment with segment drums each comprising three segment receptacles;

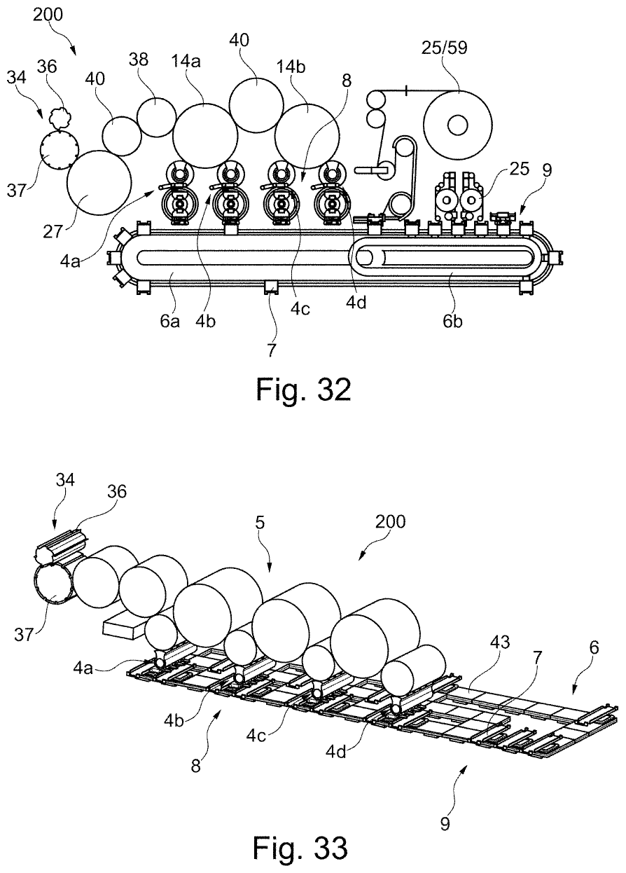

FIG. 32 shows an apparatus according to a second embodiment with a two-part transport system; and

FIG. 33 shows an apparatus according to a second embodiment with a planar transport system.

FIG. 1 shows an apparatus 100 for forming and conveying cell stacks 3 formed by segments 2 for the energy cell producing industry. The apparatus 100 comprises a feed is device 5, four cell stacking devices 4a, 4b, 4c, 4d and a transport system 6.

A cutting device 34 for cutting a continuous web 35 is provided upstream of the feed device 5.

The cutting device 34 is fed with a continuous web 35 consisting of two continuous webs of a separator material having anode sheets arranged between them and spaced apart in the longitudinal direction of the continuous web 35 and cathode sheets lying on one side of one of the continuous webs of the separator material and also spaced apart in the longitudinal direction of the continuous web. It goes without saying that it is in principle also possible to swap around the arrangement of the anode sheet and the cathode sheet in the continuous web 35. If the continuous web has spaced electrode sheets, the cut in the cutting device 34 is made through the separation locations between the electrode sheets. The supplied continuous web 35 is a four-ply web, so that the segments 2 cut therefrom correspond to the monocells described above. Of course, segments 2 of other types are also possible.

Here, the cutting device 34 is formed by a pair of drums consisting of a cutting drum 36 having cutting knives and a counter-drum 37 designed as a suction roller having counter-knives, and cuts the continuous web 35 guided onto the cutting drum 36 or the counter-drum 37 into segments 2 of a predetermined length by shearing the cutting knives against the counter-knives, which predetermined length is defined by the distances between the cutting knives. Starting from the cutting device 34, the cut segments 2 are fed to the feed device 5.

The feed device 5 further comprises a reject device comprising a test drum 27, an ejection drum 38 and a rejects reservoir 39 (see FIG. 2). The test drum 27 is designed to detect defective segments 2, for example by means of an electrical test instrument. From the test drum 27, not only the undamaged but also the damaged segments 2 are transferred by means of a transport drum 40 to the ejection drum 38, where the damaged segments 2 are removed from the production process and sent to the rejects reservoir 39.

In this embodiment, the feed device 5 comprises four transfer drums 14a, 14b, 14c, 14d for transferring segments 2 to the four cell stacking devices 4a, 4b, 4c, 4d. The ejection drum 38 transfers the undamaged segments 2 to the first transfer drum 14a, from which a partial quantity of the segments 2 is transferred to the further transfer drums 14a, 14b, 14c, 14d by means of further transport drums 40.

It goes without saying that the feed device 5 can comprise further components or assemblies not shown in FIG. 1. These include, for example, devices for aligning intermediate products, such as a device for web edge control after lamination of the monocells, which is arranged downstream of the reject device. Because web edge control can only be used to control a continuous web, it is arranged in the production process before cutting and before the reject device.

Each of the cell stacking devices 4a, 4b, 4c, 4d comprises a segment drum 15a, 15b, 15c, 15d in the form of a removal stamp driven into a rotational movement. The segment drums 15a, 15b, 15c, 15d are designed to remove the segments 2 from a transfer drum 14a, 14b, 14c, 14d assigned to said segments and to stack said segments to produce a cell stack 3.

The rotational movement of the segment drums 15a, 15b, 15c, 15d is controlled such that they take the segments 2 from the transfer drums 14a, 14b, 14c, 14d in a predetermined sequence. In the present embodiment, four segment drums 15a, 15b, 15c, 15d are provided, so that each of the segment drums 15a, 15b, 15c, 15d takes the segments 2 from the transfer drums 14a, 14b, 14c, 14d in a fixed sequence in a four-beat rhythm. The segment drum 15a assigned to the first transfer drum 14a thus takes a segment 2 from the circumference of the first transfer drum 14a during one revolution. The rotational movement of the segment drum 15a is here coordinated with the rotational movement of the first transfer drum 14a in such a way that, when the first transfer drum 14a is fully loaded, it takes over a total of one quarter of the segments 2 held on the first transfer drum 14a. It goes without saying that the first transfer drum 14a is fully loaded only when none of the segments 2 have been ejected by the ejection drum 38. The segments 2 remaining on the first transfer drum 14a are then taken over by a transport drum 40 and transferred to the second transfer drum 14b, from which some of the segments 2 are then removed by the second segment drum 15b. In a corresponding manner, the segments 2 are then transferred by further transport rollers 40 to the third and fourth transfer drums 14c and 14d, so that the segments 2 are also removed from the third and fourth segment drums 15c and 15d and stacked in order to produce cell stacks 3. In this way, the segments 2 can be evenly distributed on the segment drums 15a, 15b, 15c, 15d. The segments 2 are thus fed by the feed device 5 in a continuous inflow and from there discharged to the cell stacking device 4a, 4b, 4c, 4d in a successive transfer for parallel stacking. In the first embodiment shown in FIG. 1, the cell stacks 3 are formed on transport units 7 of the transport system 6, which were previously removed from the transport system 6. The transport unit 7 is removed from the transport system 6 by means of a lift 13a, which transports the particular transport unit 7 from a transport system level 12 to a level 11 of a changing device 10 arranged above it. By means of the changing device 10, the empty transport unit 7 is then positioned in relation to the particular cell stacking device 4a, 4b, 4c, 4d in such a way that the segments 2 can be placed on top of each other on the transport unit 7 in order to produce cell stacks 3. The transport unit 7 with the cell stack 3 arranged thereon is then routed by means of the changing device 10 to a second lift 13b by means of which the transport unit 7 together with the cell stack 3 can be moved back to the transport system level 12.

The transport system 6 is designed to convey the transport units 7 loaded with cell stacks 3 from a pick-up area 8 to a delivery area 9, where the cell stack 3 is removed from the transport unit 7 by means of an unloading apparatus 26. The empty transport units 7 are then made available again for loading in the pick-up area 8 via a return path 44.

FIG. 2 is a detailed view of the apparatus 100 according to the first embodiment. The cutting device 34, to which the continuous web 35 is fed, can be seen in detail. In addition, the rejects reservoir 39, into which defective segments 2 are ejected, is shown schematically. If defective segments 2 are ejected at the ejection drum 38, the first transfer drum 14a cannot be completely filled with segments 2. Depending on where the segment 2 is missing, the previously ejected segment 2 will be missing when the cell stack 3 is formed by the first, second, third or fourth segment drum 15a, 15b, 15c, 15d. Consequently, the cell stack 3 can only reach the predefined cell stack height with a time delay. How this time delay is compensated for will be explained later on.

FIG. 3 shows the state of removal of the segments 2 from the first and second transfer drums 14a and 14b by means of the first and second segment drums 15a and 15b. The removal by the third and fourth segment drums 15c and 15d takes place according to exactly the same principle. In order to avoid repetition, however, only the process of cell stacking will be described up to the transfer to the transport system 6, starting from the removal of the segments 2 from the first transfer drum 14a.

In FIG. 3 it can be seen that the segment drums 15a project towards the transfer drum 14a for receiving the segment 2 (not shown) to be transferred. The segment drum 15a is rotated at such a speed that the segment 2 can be picked up at a transfer speed corresponding to the circumferential speed of the transfer drum 14a. The segment 2 can thus be transferred to the segment drum 15a without braking. To receive the segments 2, the segment drum 15a is subjected to a negative pressure. After the segments 2 have been received, the segment drum 15a is braked to a delivery speed of zero, so that the respective segment 2 can be stacked to produce a cell stack 3 on a transport unit 7 while at a standstill. After the segment 2 has been delivered to the transport unit 7, the segment drum 15a is accelerated back up to the transfer speed.

The diagram in FIG. 4 shows the time course of the angle of one of the segment drums 15a, 15b, 15c, 15d. The time is plotted in seconds on the abscissa and the angle of rotation of the segment drum 15a, 15b, 15c, 15d is plotted in degrees on the ordinate.

FIG. 5 shows the time course of the angular velocity for the movement from FIG. 4. The time is plotted in seconds on the abscissa and the angular velocity of the segment drum 15a, 15b, 15c, 15d is plotted in degrees per second on the ordinate.

It can be seen from FIGS. 4 and 5 that during the interval 50 of the reception of the segment 2 from the transfer drum 14a-14d, the speed, namely the transfer speed, is kept constant; in this case it is 600°/s. In a subsequent interval 51 of acceleration, the speed is increased to more than 1600°/s. Subsequently, deceleration to an angular velocity of 0°/s takes place in an interval 52. This is followed by a relatively short standstill interval 53, during which the segment 2 is delivered to the transport unit 7 to form the cell stack 3. After the delivery of the segment 2, the segment drum 15a-15d is accelerated again in a further interval 54 of acceleration to more than 1600°/s and then decelerated in a further interval 55 to the transfer speed, so that the segment drum 15a-15d can again receive a new segment 2 from the transfer drum 14a-14d in the receiving interval 50. The process is then repeated. The angular velocities and the accelerations depend, inter alia, on the web speed, the diameter of the segment drums 15a-15d, the number of receiving stamps and the acceleration ramps of the drives. Accordingly, the values may differ from those stated here.

FIG. 6 shows the placement of the segment 2 on one of the transport units 7. It can be seen that the transport unit 7 is formed by a container which is open at the top and in which the cell stack 3 can be formed. In FIG. 6, the segment drum 15a is rotated downwards with the receptacle for the segment 2. The segment 2 is delivered to the transport unit 7 by means of a depositing element 16 comprising a plurality of parallel prongs 17 which extend from a base part 18. In the illustrated position of the segment drum 15a, the prongs 17 engage in corresponding recesses 19 of the segment drum 15a. Furthermore, the comb-like depositing element 16 is mounted so as to be rotatable about a longitudinal axis of the base part 18, so that the segment 2 can be combed out by the prongs 17 by means of a corresponding rotation. Alternatively, the depositing element 16 can also deposit the segment 2 in or on the transport unit 7 by means of a purely vertical lifting movement. The depositing element 16 can be actuated, for example, by means of an actuator (not shown).

FIG. 7 shows that the transport unit 7 has a setdown surface 21 having recesses 22. In the position in which the transport unit 7 is loaded with the segments 2, fins 20 project into the recesses 22, wherein the degree of engagement of the fins 20 in the recesses 22 can be adjusted by means of an adjusting device 45. Due to this adjustability, the fins 20 can form the height-adjustable base for the transport unit 7.

Furthermore, FIG. 7 shows the position of the changing device 10 immediately before the transfer of an empty transport unit 7 from the schematically shown transport system 6 to the changing device 10 arranged above it. The changing device 10 comprises a frame which is designed to support two transport units 7. FIG. 7 shows an empty first storage position 41 into which the unloaded transport unit 7 can be conveyed by means of the first lift 13a. A second storage position 42 is occupied by a transport unit 7. The transport unit 7 in the second storage position 42 is positioned by the changing device 10 such that the cell stack 3 can be formed thereon by the segment drum 15a.

FIG. 8 shows the changing device 10, in which both the first and the second storage positions 41, 42 are occupied by a transport unit 7. On the transport unit 7, which is located in the second storage position 42, a defined number of segments 2 is is reached, so that a plurality of gripper arms 46 of the transport unit 7 are closed by means of an actuator 47, so that they come into contact with the uppermost segment 2 of the cell stack 3 and thus hold it in place in the transport unit 7. In this case, the actuator is not part of the transport unit 7.

FIG. 8 shows the displacement of the changing device 10 so that the transport unit 7 located in the second storage position 42 can be conveyed back to the transport system level 12 (cf. FIG. 1) by the second lift 13b. In order to move the changing device 10 from the first position, which is shown in FIGS. 6 and 7, to said second position, the fins 20 must be moved completely out of the recesses 22 of the setdown surface 21 (cf. FIG. 7). In this second position of the changing device 10, the loaded transport unit 7 is in the second storage position 42, ready to be picked up by the second lift 13b. In this position, the transport unit 7 in the first storage position 41 can be filled with segments 2 from the segment drum 15a in order to form the cell stack 3.

FIG. 9 shows that the changing device 10 can be moved translationally back and forth by a rotary drive 48 on the level 11 (cf. FIG. 1) of the changing device 10, wherein the direction of rotation of the rotary drive 48 changes to effect the back and forth movement. For this purpose, the changing device 10 is kinematically connected to the rotary drive 48 by means of a corresponding motion converter 49.

FIG. 10 shows the movement of the changing device 10 in a time/distance diagram. The time is plotted in seconds on the abscissa and the distance of displacement is plotted in meters on the ordinate. In FIG. 11, the same movement of the changing device 10 is plotted in a speed/time diagram. The time is plotted in seconds on the abscissa and the speed is plotted in m/s on the ordinate.

From the diagrams of FIGS. 10 and 11, it can be seen that in a first interval 60 the changing device 10 is at a standstill. In this interval 60, the cell stack 3 is formed on the transport unit 7 which is movable by means of the changing device 10 and is located in the second storage position 42. In addition, an empty transport unit 7 can be received in is the first storage position 41 in this interval 60. This is followed by an interval 61 in which the changing device 10 is accelerated constantly to a value of 0.7 m/s. This is followed by a constant deceleration of the changing device 10 to a speed of 0 m/s in an interval 62. In a subsequent standstill interval 63, for example, the transport unit 7 with the cell stack 3 in the second storage position can be transferred to the transport system 6 by means of the second lift 13b, while a new cell stack 3 can already be formed on the transport unit 7 in the first storage position. The changing device 10 is then moved back with the same speed profile. However, when the changing device 10 is being moved back, the transport unit 7 on which the cell stack 3 is formed is held in position so that said transport unit 7 is moved from the first storage position 41 to the second storage position 42. The transport unit 7 is held in position during the displacement movement by the fins 20 which project into the recesses 22 of the transport unit 7.

FIG. 12 shows the transfer of the transport unit 7 with the cell stack 3 formed thereon to the schematically shown transport system 6. For this purpose, the changing device 10 is in the second position so that the transport unit 7 with the cell stack 3 can be lowered to the transport system level 12 (cf. FIG. 1) by the lift 13b. The transport system 6 comprises, for example, individually movable transport vehicles with which the transport units 7 can then be conveyed. While the transport unit 7 is being removed from the transport system 6, the corresponding transport vehicle (not shown) is in a parking position ready to take over the transport unit 7 loaded with the cell stack 3. After the transport unit 7 has been taken over by the transport system 6, the latter cycles the cell stack 3 into subsequent process steps.

FIG. 13 is a perspective view of the apparatus 100 according to the first embodiment. In addition, the ejection of defective segments 2 into a rejects reservoir 39 is shown by means of an arrow 56. Further arrows 57, 58, of which only two are provided with reference signs for the sake of clarity, schematically illustrate the removal is (arrow 57) of the transport unit 7 from the transport system 6 and the return thereof (arrow 58). Due to the ejection of the defective segments 2, the cell stacks 3 can sometimes only be completed with a time delay, so that the finished cell stacks 3 cannot be transferred to the transport system 6 in the pick-up area 8 even with a fixed clocking. In order to compensate for any gaps between the transport units 7 in the transport system 6, the transport units 7 can be moved individually in the transport system 6. Further details will be explained below with reference to FIG. 28. The transfer of the transport units 7 from the transport vehicles (not shown) takes place in such a way that the particular transport vehicle is moved into a first transfer position in which the transport unit 7 is transferred to the changing frame 10 in the direction of the arrow 57. Immediately after this transfer, the transport vehicle (not shown) moves to a second transfer position in which an already formed cell stack 3 can be taken up on a transport unit 7. The transport vehicle is only driven to the first transfer position, i.e. to the lift 13a, when a finished cell stack 3 is ready for transfer to a transport unit 7 at the second transfer position, i.e. at the lift 13b. In this way, the cell stacks 3 can be transported away serially without the transport vehicles (not shown) interfering with each other.

The movement of the transport vehicles in the pick-up area 8 is shown in FIGS. 14 and 15. FIG. 14 shows a distance/time diagram in which the time is plotted in seconds on the abscissa and the distance is plotted in meters on the ordinate. FIG. 15 shows a speed/time diagram in which the time is plotted in seconds on the abscissa and the speed is plotted in m/s on the ordinate. In a first interval 70, the transport vehicle is accelerated from standstill and decelerated again until it reaches the first transfer position; there, in the subsequent interval 71, the empty transport unit 7 is transferred from the transport vehicle to the changing device 10 while at a standstill. Immediately after the transfer, the transport vehicle is accelerated and decelerated again in an interval 72 without the transport unit 7, so that the transport vehicle is at a standstill in an interval 73, ready to receive the transport unit 7 loaded with the cell stack 3. In a subsequent interval 74, the transport vehicle with transport unit 7 and cell stack 3 is accelerated again in order to be moved into the delivery area 9 (cf. FIG. 13).

FIG. 16 shows the movement profile of the transport vehicles or transport units 7 in the delivery area 9 by means of a speed/time diagram. The time is plotted in seconds on the abscissa and the speed is plotted in m/s on the ordinate. It can be seen that acceleration/deceleration intervals 75 alternate with standstill intervals 76, so that a predefined production cycle set in the delivery area 9. Here, for example, the production cycle is 1.8 seconds and includes the acceleration/deceleration interval 75 with a duration of 0.8 seconds and the standstill interval 76 with a duration of 1 second. However, the production cycle depends on the web speed of the segments 2 and on the number of segments 2 in a stack 3. The production cycle can be adjusted accordingly. The standstill intervals 76 can be used for further processing or for removing the cell stack 3 from the transport unit 7.

FIG. 17 shows the apparatus 100 comprising a processing device 25 in the form of an application device 59 for subsequent application of an additional anode layer. In principle, it is also possible to place this in the transport unit 7 before the cell stack 3 is formed. In addition, a further processing device 25 is provided, which can be used, for example, for taping, welding and/or punching the cell stack 3.

FIG. 18 schematically shows a method 300 for forming and transporting cell stacks 3 formed by segments 2 for the energy cell producing industry, comprising the following steps: In a method step a) a plurality of transport units 7 are moved between the pick-up area 8 and the delivery area 9 by a transport system 6. In a method step b) one or more of the transport units 7 are removed from the transport system 6 in a pick-up area 8 of the transport system 6. In a method step c) segments 2 are stacked in parallel to produce cell stacks 3 of a predefined cell stack height on the removed transport units 7 by means of four cell stacking devices 4a, 4b, 4c, 4d. In a method step d) the removed transport unit(s) 7 together with the cell stack 3 arranged on the transport unit 7 are returned to the transport system 6 as soon as the cell stack 3 on the particular transport unit 7 has reached the predefined cell stack height. It has proven advantageous to carry out the method 300 with the apparatus 100 described in FIG. 1 to 17.

FIG. 19 shows an apparatus 200 for forming and conveying cell stacks 3 from segments 2 according to a second embodiment. To avoid repetition, the following will focus only on the differences compared to the apparatus 100. In this embodiment, the segments 2 are also transferred to the four cell stacking devices 4a-4d by transfer drums 14a and 14b. However, in this case only two transfer drums 14a and 14b are provided, from which the segments 2 are removed. The cell stacking devices 4a-4d are each formed by a segment drum 15a-15d. The first two segment drums 15a and 15b take over the segments 2 from the first transfer drum 14a; the third and fourth segment drums 15c and 15d take over the segments 2 from the second transfer drum 14b. The segments 2 are stacked to produce cell stacks 3 in magazine drums 29, which will be explained in more detail below, and are then delivered to the transport system 6 comprising individually movable transport units 7. In this embodiment, the transport units 7 are formed by transport vehicles.

FIG. 20 shows a portion of the apparatus 200, in which the structure of the first magazine drum 29a can be seen. The remaining three magazine drums 29b-29d have an identical structure. The segments 2 are deposited into four parallel magazine drums 29a-29d by the segment drums 15a-15d, in which magazine drums the segments 2 are placed on top of each other in order to produce four cell stacks 3 and are then delivered to the transport system 6. In this embodiment, the magazine drum 29a has two magazines 28 arranged on its outer circumference, which are open towards the outside. The cell stacks 3 formed in the magazines 28 are then delivered to the transport units 7.

The transfer of the segments 2 and the formation of the cell stacks 3 starting from the transfer drum 14a is shown below. However, the formation of the remaining cell stacks 3 starting from the transfer drum 14b follows the same principle and is therefore not explained further.

FIG. 21 shows in detail the reception of the segments 2 from the transfer drum 14a by the segment drums 15a and 15b. The segment drums 15a and 15b take over the segments 2 from the transfer drum 14a with no relative speed, i.e. at the same circumferential speed as the transfer drum 14a, and then decelerate to a standstill so that the segments 2 can be transferred from the segment drums 15a and 15b to the corresponding magazine 28 at a standstill. The transfer to the magazines 28 of the magazine drums 29a and 29b is shown in FIG. 22. With regard to the movement and speed profile of the segment drums 15a-15d, reference is made to FIGS. 4 and 5 and the associated description.

In the position of the segment drum 15a shown in FIG. 22, one of the segments 2 is delivered to the magazine 28 of the magazine drum 29a. The segment 2 can be taken over from the segment drum 15a by means of a depositing element 16, which has a base part 18 and prongs 17 which project therefrom and are arranged parallel to one another. For this purpose, a vacuum is additionally switched off at the segment drum 15a and switched on at the depositing element 16. The depositing element 16 is mounted so as to be rotatable about the longitudinal axis of its base part 18, so that by means of a corresponding rotational movement of the base part 18, the prongs 17 deposit the segment 2 into the magazine 28 of the magazine drum 29a. Alternatively, the depositing element 16 can also deposit the segment 2 into the magazine 28 by means of a purely vertical lifting movement. For this purpose, the prongs 17 of the depositing element 16 engage in corresponding recesses 19 of the segment drum 15a. In addition, the magazine 28 has a lifting device 30 with which the depth of the magazine 28 can be adjusted depending on the increasing stack height of the segments 2 in the magazine 28. The lifting device 30 thus comprises an adjustable base on which the segments 2 can be placed on top of each other to produce the cell stack 3. The lifting device 30 can be operated by an actuator of the magazine drum 29a itself or by an external actuator, which is however part of the apparatus 200.

FIG. 23 shows the fastening of the fully formed cell stack 3 in the magazine 28. This takes place as soon as the cell stack 3 is fully formed, i.e. a predefined number of segments 2 have been placed on top of each other. The fastening is effected by means of gripper elements 31, which are pivotably arranged on the magazine drum 29a. Six gripper elements 31 are provided per magazine 28, which engage the uppermost layer of the cell stack 3. In addition, the gripper elements 31 are coupled to the lifting device 30, so that the distance between the adjustable bottom of the magazine 28 and the surface with which the gripper elements 31 rest on the cell stack 3 can be kept constant even as the lifting device 30 is adjusted. After the cell stack 3 has been fastened in the magazine, the magazine drum 29a is rotated by 180° within one depositing cycle so that the finished cell stack 3 can be fed to the transport system 6 arranged below the magazine drum 29a. After this 180° rotation, the magazine drum 29a is again at a standstill, so that the transfer of the cell stack 3 from the lower magazine 28 to the transport system 6 can take place at a standstill. As soon as a finished cell stack 3 is ready to be picked up at the lower magazine 28, a transport unit 7 moves to a corresponding pick-up position to receive the cell stack 3. At the same time, a new cell stack 3 can be formed in the upper magazine 28 of the same magazine drum 29a.

The actual transfer of the cell stacks 3 to the transport system 6 is shown in FIG. 24. The gripper elements 31 fasten the cell stack 3 to the bottom of the magazine 28. The base, as part of the lifting device 30, is then moved in the direction of the transport unit 7 located below the magazine drum 29b. For the purpose of better illustration of the lifting movement, no transport unit 7 is shown below the magazine drum 29a, which is why reference is made here to the transport unit 7 located below the magazine drum 29b. Because the gripper elements 31 are coupled to the lifting device 30, the cell stack 3 can be transferred to the transport unit 7 in the fastened state. After the cell stack 3 has been transferred to the transport unit 7, the lifting device 30, i.e. the empty base, is retracted into the magazine drum 29b. The cell stack 3, which has now been transferred to the transport system 6, is now clocked into subsequent process steps by the transport system 6.

FIG. 25 is a perspective view of the apparatus 200 according to the second embodiment. In addition, the ejection of defective segments 2 into the rejects reservoir 39 is shown by means of the arrow 56. The transfer of the finished cell stacks 3 to the transport units 7 of the transport system 6 is shown schematically by further arrows 64, of which only two are provided with reference signs for the sake of better clarity. Due to the ejection of the defective segments 2, the cell stacks 3 can sometimes only be completed with a time delay, so that the finished cell stacks 3 are not transferred to the transport system 6 in the pick-up area 8 even with a fixed clocking. As soon as a cell stack 3 is ready, a transport unit 7 can be requested to receive the finished cell stack 3. In order to compensate for any gaps between the transport units 7 in the transport system 6, the transport units 7 can be moved individually in the transport system 6. Further details will be explained below with reference to FIG. 28.

FIG. 26 shows an apparatus 200 with an application device 59 for subsequent application of an additional anode layer. In principle, it is also possible for this to be placed in the transport unit 7 before the cell stack 3 is formed. The test drum 27 (cf. FIG. 20) is not shown in FIG. 26 for the sake of clarity.

FIG. 27 schematically shows a method 400 for forming and conveying cell stacks 3 formed by segments 2 for the energy cell producing industry. Said method comprises the following steps In a method step a) segments 2 are stacked in parallel to produce cell stacks 3 of a predefined cell stack height by means of at least two cell stacking devices 4a, 4b, 4c, 4d, wherein the cell stacks 3 are formed in magazines 28 of a plurality of magazine drums 29a, 29b, 29c, 29d, wherein each magazine drum 29a, 29b, 29c, 29d is assigned to a cell stacking device 4a, 4b, 4c, 4d. In a method step b) the depth of the magazines 28 is adjusted during the cell stacking process to the height of the cell stack 3 located in the particular magazine 28, so that the segments 2 to be placed are placed at a constant height onto the cell stack 3. In a method step c) the cell stack 3 is clamped in the magazine 28 after the predefined cell stack height is reached. In a method step d) the cell stack 3 is transferred in the clamped state to one of a plurality of individually movable transport units 7 of a transport system 6 in a pick-up area 8. In a method step e) any time delays in the formation of the cell stacks 3 are compensated for by controlling and/or regulating the movement speed and/or the movement route of the transport unit 7 in a compensation area 24 arranged between the pick-up area 8 and a delivery area 9, so that the cell stacks 3 reach the delivery area 9 in a predefined time interval. It has proven advantageous to carry out the method 400 with the apparatus 200 described in FIG. 19 to 26.

The method step e) can also follow the method 300 described with reference to FIG. 18, because delays can also occur during the formation of the cell stacks 3 in the transport unit 7 positioned by the changing device 10 (cf., for example, FIG. 3) as a result of segments 2 being ejected beforehand.

The embodiments described below with reference to FIG. 28 to 32 are in principle compatible with both the apparatus 100 and the apparatus 200. A corresponding combination with the apparatuses 100 and 200 is intended to be an explicit part of the disclosure content of this application.

FIG. 28 is a schematic representation of the transport system 6, which allows any gaps between the transport units 7 to be compensated for by the individual mobility of the transport units 7, so that they can be provided in the pick-up area 9 with a predetermined clocking.

Four cell stacking devices 4a, 4b, 4c and 4d are provided on which cell stacks 3 can be formed in parallel and the cell stacks 3 can be transferred to the transport system 6 as described above. In addition, the transport units 7 are shown, which can be moved on a rail system which defines transport paths 65, 66. The transport units 7 can be conveyed, for example, by means of transport vehicles which travel on the rail system. In principle, however, other possibilities for conveying the transport units 7 are is also conceivable.

The transport units 7 or transport vehicles are driven, for example, by stationary motor modules (not shown) which are arranged along the rail system. Alternatively, the transport units 7 or the transport vehicles can each have their own drive, for example in the form of an electric motor. For the sake of simplicity, only transport units 7 will be referred to below, even though they are moved by transport vehicles.

FIG. 28 shows two empty transport units 7, i.e. not loaded with cell stacks 3, which are positioned in a waiting area 32. If necessary, these can be called to the pick-up area 8 in order to receive finished cell stacks 3 or so that the cell stack 3 can be formed on the transport unit 7.

The cell stacks 3 are then brought by means of the transport units 7 along the transport path 65 to the delivery area 9, where, for example, a processing unit 25 for processing the cell stacks 3 and an unloading apparatus 26 for unloading the cell stacks 3 from the transport unit 7 are provided.

In addition, a control unit 23 is provided with which the movement of the transport units 7 can be individually controlled and/or regulated.

As already explained above, it may be necessary to remove defective segments 2 from the production process by means of the reject drum 38 (cf. FIG. 1 or FIG. 19). As a result, the cell stacks 3 cannot always be provided at the cell stack devices 4a-4d with a predetermined clocking. On the other hand, it is advantageous for reliable further processing of the cell stacks 3 if they are provided in the delivery area 9 in a predefined production cycle, i.e. at predefined constant time intervals. A compensation area 24 is therefore provided in which the movement speed can be adjusted by means of the control device 23 such that the transport units 7 reach the delivery area 9 in a predetermined production cycle. As a result, the transport units 7 in the delivery area 9 can be moved equidistantly from one another at a constant speed. Due to this regular and continuous movement of the transport units 7 in the delivery area 9, the cell stacks 3 can be easily removed from the transport unit 7 using the unloading apparatus 26 and thus fed to a downstream process. The empty transport units 7 are then driven back to the waiting area 32 via the transport path 66, where they are ready for further loading in the pick-up area 8. In this embodiment, the waiting area 32 is provided ahead of the curve over which the transport units 7 are driven into the pick-up area 8. By arranging the waiting area 32 ahead of the curve, the transport units 7 can wait while suspended on the rail system. If the waiting area 32 were to extend into the curve, the transport units 7 would have to be held against the force of gravity, which would lead to increased energy consumption. In the pick-up area 9, the transport units 7 are then moved according to the stop-and-go principle.

FIG. 29 shows a processing unit 25 in detail, which can be arranged, for example, in a delivery area 9. By means of the transport system 6, the individually movable transport units 7 loaded with the cell stacks 3 are fed to the processing unit 25 at equidistant intervals. The processing unit 25 comprises a fastening device 67 and various processing stations. The fastening device 67 comprises an endless drive device 68 in the form of an endless belt, an endless band or an endless chain or a combination of a plurality of these elements, and a drive device (not shown) which drives the endless drive device 68 in a rotational movement. A plurality of fastening elements 69 in the form of fastening stamps are provided on the endless drive device 68. Furthermore, control projections 80 are provided which are coupled directly or indirectly in terms of movement to the fastening elements 69 and run along a control device 81 in the form of a fixed control profile during the rotation of the fastening elements 69. In addition, a plurality of processing stations, such as a plurality of taping devices 77, punching devices 78 and welding devices 79 for processing the segments 2 or the cell stacks 3, are provided in the processing device 25. By means of the fastening elements 69, the segments 2 or the cell stack 3 can be fastened in the transport units 7 during passage through the processing stations and while the mechanical forces are being exerted there.

FIG. 30 shows segment drums 15a-15d, which are designed as double segment drums, i.e. in each case two removal stamps rotate on a axis of rotation, each of which is designed to receive a segment 2 from the corresponding transfer drum 14a and 14b and to release it again with a delay. The two sections of the double segment drum can, for example, have separate drives, i.e. be operated decoupled from each other, or work with the same drive profile but with a cyclical offset. The double segment drums are of course also compatible with the apparatus 100.

FIG. 31 shows a modification of the apparatus 100 in which, instead of the segment drums 15a-15d having only one receiving stamp, each of the segment drums 15a-15d is now provided with three receiving stamps 33. The segment drums 15a-15d, of which only the two segment drums 15a and 15b are shown for the sake of clarity, can also be driven into a rotational movement in this embodiment. The segment drums 15a-15d each have three receiving stamps 33 arranged at angles of 120 degrees to each other, the external dimensions of which can at least correspond to the external shape of the segments 2 or be even larger than these. In their cross-section perpendicular to the axis of rotation of the segment drums 15a-15d, the receiving stamps 33 have a circular arcuate contour with in each case identical radii, so that they complement each other to form a virtual circle.

The movement of the segment drums 15a-15d is controlled in such a way that one of the segment drums 15a-15d is decelerated and accelerated overall without change in the distances between the receiving stamps 33. Each of the segment drums 15a-15d is formed here by a drum driven to rotate, so that the receiving stamps 33 are in this case arranged at invariable angles to one another during the rotational movement. The receiving stamps 33 are arranged equidistant from each other and are driven together with the base body of their segment drum 15a-15d.

The transfer process is described below with reference to the segment drum 15a shown in FIG. 15. However, the transfer at the segment drum 15b and at the is segment drums 15c and 15d (not shown) (cf. FIG. 1) takes place according to the same principle.

During the transfer of one of the segments 2 from the transfer drum 14a, one of the receiving stamps 33 is in the “12 o'clock position.” The receiving stamp 33, which has taken the previous segment 2 from the transfer drum, is now in the “4 o'clock position.” In this transfer position, the segment drum 15a rotates at a circumferential speed of the lateral surfaces of the receiving stamps 33, corresponding to the circumferential speed of the segments 2 on the transfer drum 14a and, with the receiving stamp 33 in the “12 o'clock position,” is currently taking over a segment 2. A further receiving stamp 33 is located in the “8 o'clock position.” Said further receiving stamp is not carrying a segment 2 and has a free lateral surface because it has just transferred a segment 2 to the transport unit 7 located in the changing device 10. In order to transfer the segment 2 from the receiving stamp 33 located in the “4 o'clock position” to the transport unit 7, the segment drum 15a is delayed until the segment drum 15a with the receiving stamp 33 previously arranged in the “4 o'clock position” is arranged in the “6 o'clock position,” in which a delayed delivery of the segment 2 to the transport unit 7 is possible.

By means of the three receiving stamps 33, the timely transfer of the segment 2 to the transport unit 7 in the “6 o'clock position” can be ensured even without acceleration of the segment drum 15a starting from the transfer speed (cf. FIG. 5).

In principle, it is also possible for the segment drum 15a to rotate at a constant speed, so that the segment 2 is peeled off by the depositing element 16 during the rotation of the segment drum 15a.

It goes without saying that the embodiment of the segment drums 15a-15d described in FIG. 31, each having three segment receptacles 33, is also compatible with the embodiment of the apparatus 200 comprising the magazine drum 29 (cf. FIG. 19 to 26).

FIG. 32 shows a transport system 6 which is constructed in two parts. In a first part 6a, the transport units 7 can be moved flexibly and individually. This section is preferably assigned to the pick-up area 8. In a second part 6b of the transport system 6, however, the transport units 7 can no longer be moved individually, but are conveyed at a uniform movement speed and/or on a uniform movement route. Said second part is preferably assigned to the delivery area 9. The transport units 7 or the transport vehicles are therefore controlled in the first part 6a in such a way that any gaps are compensated for before reaching the second part 6b. The two-part transport system 6a, 6b is of course also compatible with the apparatus 100 in a corresponding manner.

FIG. 33 shows a transport system 6 in which the transport units 7 are not moved on a closed path, but on a planar movement surface 43. The transport units 7 can be moved more flexibly on the movement surface 43 than on a track, so that further degrees of freedom can be used. In this way, the movement route can be used more effectively to compensate for gaps. For example, points or similar elements can be implemented to determine the movement route.

1. An apparatus for forming and conveying cell stacks formed by segments for the energy cell producing industry, comprising;
at least two cell stacking devices) which are designed to place the segments on top of each other to produce cell stacks, and
at least one feed device, each of which is designed to feed the segments to the cell stacking devices, wherein
a transport system having a plurality of individually movable transport units is provided, which are designed to convey the cell stacks produced by the cell stacking devices from a pick-up area to a delivery area spatially remote from the pick-up area, wherein
in each case one of the cell stacking devices forms a cell stack in, or on, one of the transport units, and
the transport units in the pick-up area can be removed from the transport system in order to form the cell stack.

2. The apparatus according to claim 1, wherein at least one changing device is provided with which a transport unit filled with a cell stack by one of the cell stacking devices can be replaced by an empty transport unit.

3. The apparatus according to claim 2, wherein
the at least one changing device has a first and a second storage position for storing one of the transport units, wherein
the at least one changing device is designed to transfer the transport unit from the first storage position to the second storage position.

4. The apparatus according to claim 2, wherein
the at least one changing device is movable on a level which is arranged above or below a transport system level on which the transport units are removed from the transport system and/or transferred back to the transport system.

5. The apparatus according to claim 4, wherein
each of the cell stacking devices is assigned a first and/or a second lift with which the transport units can be conveyed between the level of the changing device and the transport system level.

6. The apparatus according to claim 2, wherein
the transport system comprises a plurality of transport vehicles which are designed to move the transport units individually in the transport system, wherein
the particular transport vehicle, after the transfer of one of the transport units to the at least one changing device in a first transfer position, can be moved in the unloaded state to a second transfer position in order to receive a ready transport unit with a finished cell stack.

7. The apparatus according to claim 1, wherein the segments are placed on top of one another on a height-adjustable base in, or on, one of the transport units in order to produce a cell stack.

8. The apparatus according to claim 7, wherein
the transport units each have a setdown surface having recesses for the cell stack, wherein
the apparatus comprises fins which are arranged such that they project into the recesses of the setdown surface when one of the transport units is in a position in which the transport unit is filled with segments by one of the cell stacking devices, wherein
an adjusting device is provided with which the degree of engagement of the fins in the recesses form the height-adjustable base for the transport unit.

9. An apparatus for forming and conveying cell stacks formed by segments for the energy cell producing industry, comprising;
at least two cell stacking devices which are each designed to place the segments on top of each other in order to produce cell stacks, and
a feed device which is designed to feed the segments to the cell stacking devices, wherein
a transport system having a plurality of individually movable transport units is provided, which are designed to receive the cell stacks produced by the cell stacking devices in a pick-up area and to deliver them again in a delivery area, wherein
one of the cell stacking devices, places the segments on top of each other in a magazine in order to produce the cell stack, and wherein
the magazine has a lifting device with which the depth of the magazine can be adjusted depending on the increasing stack height of the segments in the magazine.

10. The apparatus according to claim 9, wherein
the magazine drum comprises pivotable gripper elements can be fastened or released in the magazine depending on the pivoting position of the gripper elements, wherein
the pivotable gripper elements are coupled to the lifting device in such a way that the lifting device performs a lifting movement together with the gripper elements.

11. The apparatus according to claim 9, wherein a common lifting movement of the lifting device and the gripper elements allows the cell stack to be transferred to one of the transport units in a clamped state between the lifting device and the gripper elements.

12. The apparatus according to claim 9, wherein
the transport units are containers which are open on one side.

13. The apparatus according to claim 9, wherein
the transport units each comprise one or more gripper arms with which the cell stack can be fastened to the transport unit.

14. The apparatus according to claim 9, wherein
an unloading apparatus is provided in the delivery area by means of which the cell stacks are removed from the transport units, and
the unloaded transport units can be made available again by the transport system at the cell stacking devices.

15. The apparatus according to claim 9, wherein
the feed device comprises at least one transfer drum, wherein
each of the cell stacking devices comprises at least one segment drum, by means of which the segments are picked up from the transfer drum at a transfer speed and are delivered at a delivery speed, wherein
the transfer speed is greater than the delivery speed.

16. The apparatus according to claim 15, wherein
at least one comb-like depositing element having a plurality of prongs arranged parallel to one another is provided, wherein
the prongs extend from a common base part, wherein
the prongs engage in corresponding recesses of one of the segment drums during a rotational movement of the segment drum, wherein
the comb-like depositing element can be moved in translation or rotated about the longitudinal axis of the base part in order to release the segments from the particular segment drum.

17. The apparatus according to claim 9, wherein
a control device is provided which is configured to individually control and/or regulate the movement speed and/or the movement route of the transport units loaded with the cell stacks between the pick-up area and the delivery area in such a way that a delayed completion of the cell stack at one of the cell stack devices, can be compensated for in a compensation area between the pick-up area and the delivery area.

18. The apparatus according to claim 9, wherein
the feed device comprises a reject device with which defective segments can be removed from the apparatus.

19. A method for forming and conveying cell stacks formed by segments for the energy cell producing industry, comprising the following steps:
a) moving a plurality of transport units between a pick-up area and a delivery area by means of a transport system;
b) removing one or more of the transport units from the transport system in a pick-up area of the transport system;
c) stacking segments in parallel to produce cell stacks of a predefined cell stack height on the removed transport units by means of at least two cell stacking devices; and
d) returning the removed transport unit(s) together with the cell stack arranged on the transport unit to the transport system as soon as the cell stack on the particular transport unit has reached the predefined cell stack height.

20. A method for forming and conveying cell stacks formed by segments for the energy cell producing industry, comprising the following steps:
a) stacking segments in parallel to produce cell stacks of a predefined cell stack height by means of at least two cell stacking devices, wherein the cell stacks are formed in magazines of a plurality of magazine drums;
b) adjusting the depth of the magazines during the cell stacking process to the height of the cell stack located in the particular magazine, so that the segments to be placed are placed at a constant height onto the cell stack;
c) clamping the cell stack in the magazine after the predefined cell stack height is reached;
d) transferring the cell stack in the clamped state to one of a plurality of individually movable transport units of a transport system in a pick-up area; and
e) compensating for any time delays in the formation of the cell stacks by controlling and/or regulating the movement speed and/or the movement route of the transport unit arranged between the pick-up area and a delivery area, so that the cell stacks reach the delivery area in a predefined time interval.

21. The apparatus according to claim 1, wherein
the transport units are containers which are open on one side.

22. The apparatus according to claim 1, wherein
the transport units each comprise one or more gripper arms with which the cell stack can be fastened to the transport unit.

23. The apparatus according to claim 1, wherein
an unloading apparatus is provided in the delivery area by means of which the cell stacks are removed from the transport units, and
the unloaded transport units can be made available again by the transport system at the cell stacking devices.

24. The apparatus according to claim 1, wherein
the feed device comprises at least one transfer drum, wherein
each of the cell stacking devices comprises at least one segment drum, by means of which the segments are picked up from the transfer drum at a transfer speed and are delivered at a delivery speed, wherein
the transfer speed is greater than the delivery speed.

25. The apparatus according to claim 24, wherein
at least one comb-like depositing element having a plurality of prongs arranged parallel to one another is provided, wherein
the prongs extend from a common base part, wherein
the prongs engage in corresponding recesses of one of the segment drums during a rotational movement of the segment drum, wherein
the comb-like depositing element can be moved in translation or rotated about the longitudinal axis of the base part in order to release the segments from the particular segment drum.

26. The apparatus according to claim 1, wherein
a control device is provided which is configured to individually control and/or regulate the movement speed and/or the movement route of the transport units loaded with the cell stacks between the pick-up area and the delivery area in such a way that a delayed completion of the cell stack at one of the cell stack devices can be compensated for in a compensation area between the pick-up area and the delivery area.

27. The apparatus according to claim 1, wherein
the feed device comprises a reject device with which defective segments can be removed from the apparatus.
